(19) United States
(12) Patent Application Publication
(10) Pub. No.: US 2010/0265738 A1
(43) Pub. Date: Oct. 21, 2010

(54) FRAME OF EDGE-LIGHT BACKLIGHT MODULE

(76) Inventors: Chih-Hsiung LIN, Taichung City (TW); Chieh-Hsien Chen, Changhua County (TW); Fu-Hsiung Chang, Taichung County (TW)

Correspondence Address: Muncy, Geissler, Olds & Lowe, PLLC, 4000 Legato Road, Suite 310, FAIRFAX, VA, 22033, US

(21) Appl. No.: 12/424,132

(22) Filed: Apr. 15, 2009

(51) Int. Cl. F21V 7/22

(52) U.S. Cl. 362/609

(57) ABSTRACT

An edge-light backlight module includes a module frame having an upper frame and a bottom plate. A light guide plate is received in the module frame. A light source is received in the module frame and faces an enter side of the light guide plate. A lamp reflector is received in the module frame and encloses the light source. The lamp reflector is made of a soft material and has two overlapping portions overlapped with the light guide plate. Two filler members are attached on interior sides of the upper frame and the bottom plate to press the overlapping portions of the lamp reflector on the light guide plate.

### BACKGROUND OF THE INVENTION

1. Field of the Invention

The present invention relates generally to a liquid crystal display, and more particularly to a frame of an edge-light backlight module to prevent a lamp reflector from deformation.

2. Description of the Related Art

Typically, a liquid crystal display includes a liquid crystal panel and a backlight module. The illumination of the liquid crystal display comes from the backlight module but the liquid crystal panel. The conventional backlight module includes direct-light backlight module and edge-light backlight module.

FIG. 1 shows a conventional edge-light backlight module 40 including an upper frame 42 and a bottom plate 44. A light guide plate 46 is mounted between the upper frame 42 and the bottom plate 44, and a plurality of optical films 48, such as diffusive sheet, prism sheet, or the like, are placed on a top side of the light guide plate 46. A lamp 50 is mounted facing an edge side of the light guide plate 46, and a lamp reflector 52 is provided covering the lamp 50. The lamp 50 emits light entering the light guide plate 46, and the light guide plate 46 reflects the light upwards and through the optical films 48 to provide a uniform light source to the liquid crystal panel. The lamp reflector 52 may reflect the light of the lamp 50 to the light guide plate 46 to increase the light enter efficiency.

In early days, the lamp reflectors 52 are made of metal to be bent for a predetermined shape. In operation, we find a light linkage occurred in a gap between the lamp reflector 52 and the light guide plate 46. To fix this problem, some attach a tape 54 on conjunctions of the lamp reflector 52 and the light guide plate 46.

In present days, more and more lamp reflectors are made of paper or plastic that the lamp reflectors are flexible. Such flexible lamp reflectors will be deformed by heat of the lamp that the tape will loose its function and there is still a light linkage problem in the present backlight module.

### SUMMARY OF THE INVENTION

The primary objective of the present invention is to provide an edge-light backlight module, which may prevent light linkage problem in the backlight module with a flexible lamp reflector.

According to the objective of the present invention, an edge-light backlight module includes a module frame having a window thereon; a light guide plate, which is received in the module frame, having an enter side, an exit side, and a bottom side; a light source received in the module frame and facing the enter side of the light guide plate; a lamp reflector received in the module frame and enclosing the light source, wherein the lamp reflector is made of a soft material and has at least an overlapping portion overlapped with the light guide plate; and a filler member received in the module frame between the overlapping portion of the lamp reflector and an interior side of the module frame. The filler member has opposite sides touching the overlapping portion of the lamp reflector and an interior side of the module frame respectively to press the overlapping portion of the lamp reflector on the light guide plate.

### BRIEF DESCRIPTION OF THE DRAWINGS

FIG. 1 is a sectional view of the conventional edge-light backlight module;

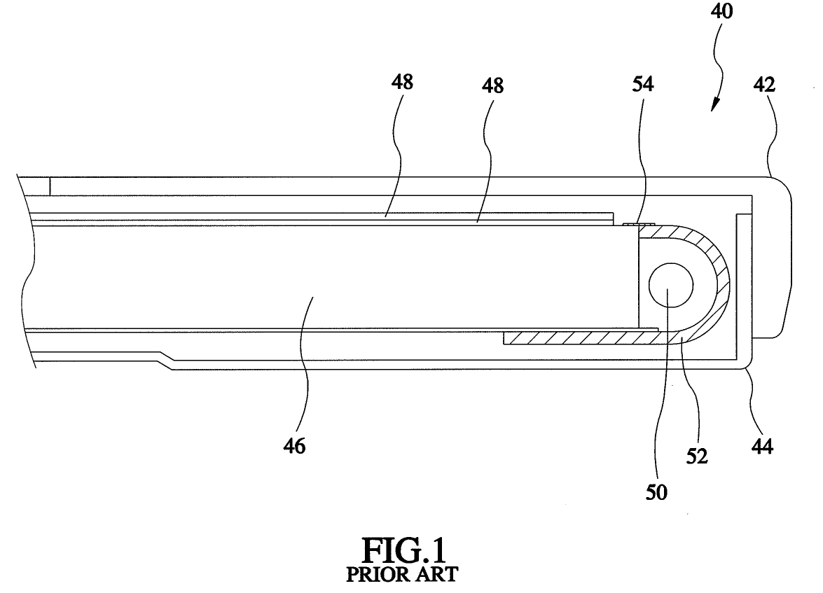

FIG. 2 is a sectional view of a preferred embodiment of the present invention;

FIG. 3 is a perspective view of a part of the preferred embodiment of the present invention, showing the filler member; and

FIG. 4 is a perspective view of a part of the preferred embodiment of the present invention, showing another filler member.

### DETAILED DESCRIPTION OF THE INVENTION

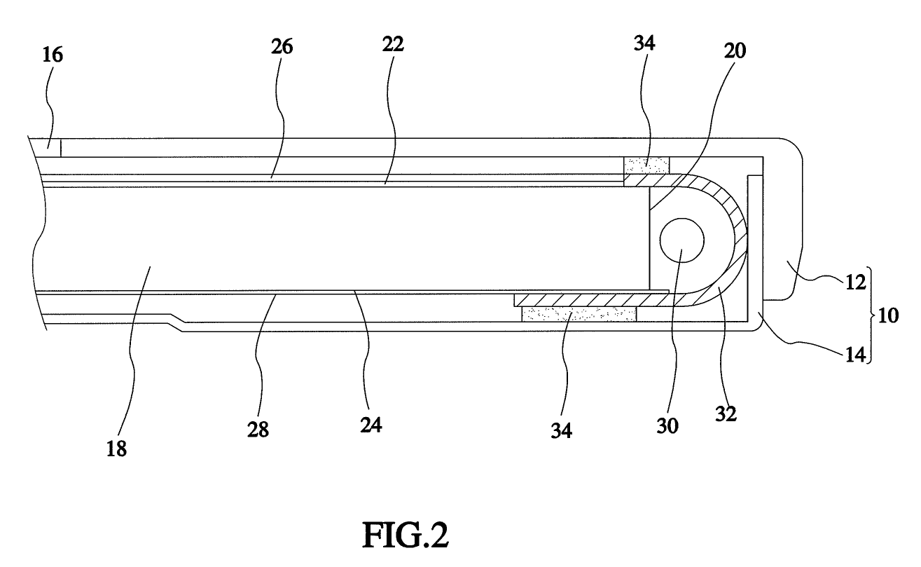

As shown in FIG. 2, an edge-light backlight module of the preferred embodiment of the present invention includes:

A module frame 10 includes an upper frame 12 and a bottom plate 14, wherein the upper frame 12 has a window 16.

A light guide plate 18 is provided in the module frame 10 and has an enter side 20, an exit side 22, and a bottom side 24. The exit side 22 is on a top of the light guide plate 18 facing the upper frame 12; the bottom side 24 is opposite the exit side 22, and the enter side 20 is on an edge of the light guide plate 18 between the exit side 22 and the bottom side 24. Optical films, such as diffusive sheet, prism sheet, or the like, are placed on the exit side 22 of the light guide plate 18. The light guide plate 18 is provided with a pattern 28 on the bottom side 24 to reflect light to the exit side 22.

A light source 30, which may be a cold cathode fluorescent lamp (CCFL), light emitting diodes (LED), or the like, is mounted in the module frame 10 facing the enter side 20 of the light guide plate 18.

A lamp reflector 32, which is made of paper, plastic, or other soft materials, is molded as a U-like shape to cover the light source 30. The lamp reflector 32 has two free ends, defined as overlapping portions hereafter, overlapped with the light guide plate 18 at the exit side 22 and the bottom side 24 respectively.

Two strip-like filler members 34 are provided on and under the lamp reflector 32 respectively to be pressed by the upper frame 12 and the bottom plate 14 that the filler members 34 may press the overlapping portions of the lamp reflector 32 tightly on the exit side 22 and the bottom side 24 of the light guide plate 18 respectively. The filler members 34 may be made of a flexible material, such as rubber, foam, or the like. The filler members 34 may press the overlapping portions of the lamp reflector 32 tightly on the exit side 22 and the bottom side 24 of the light guide plate 18 even when the lamp reflector 32 is deformed by the heat of the light source 30.

The filler members 34 may be attached on interior sides of the upper frame 12 and the bottom plate 14 by glue, adhesive, tape, or the like. The filler members 34 also may be directly projected from the interior sides of the upper frame 12 and the bottom plate 14.

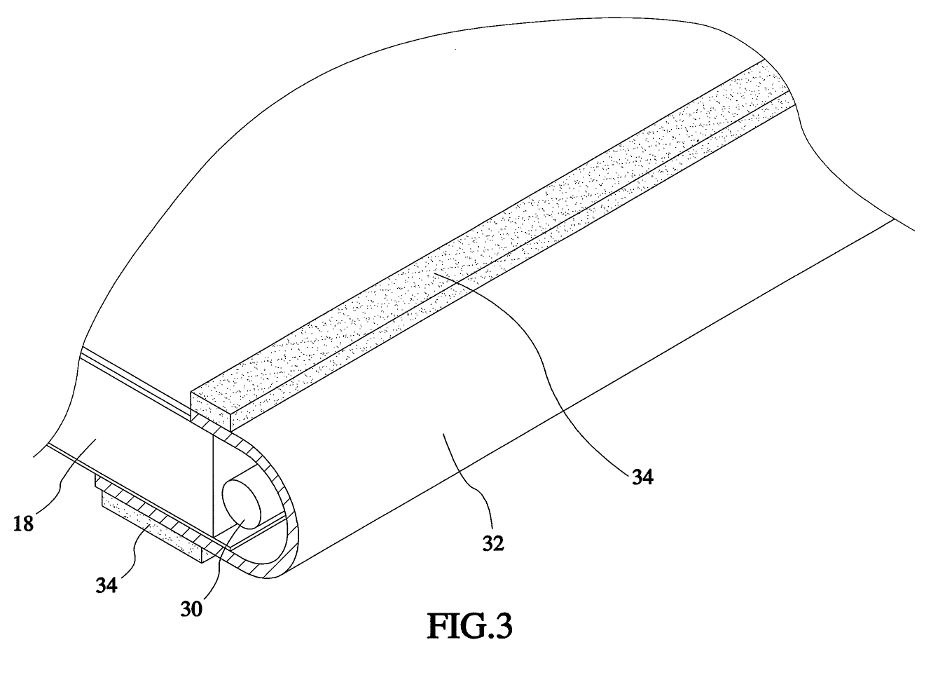

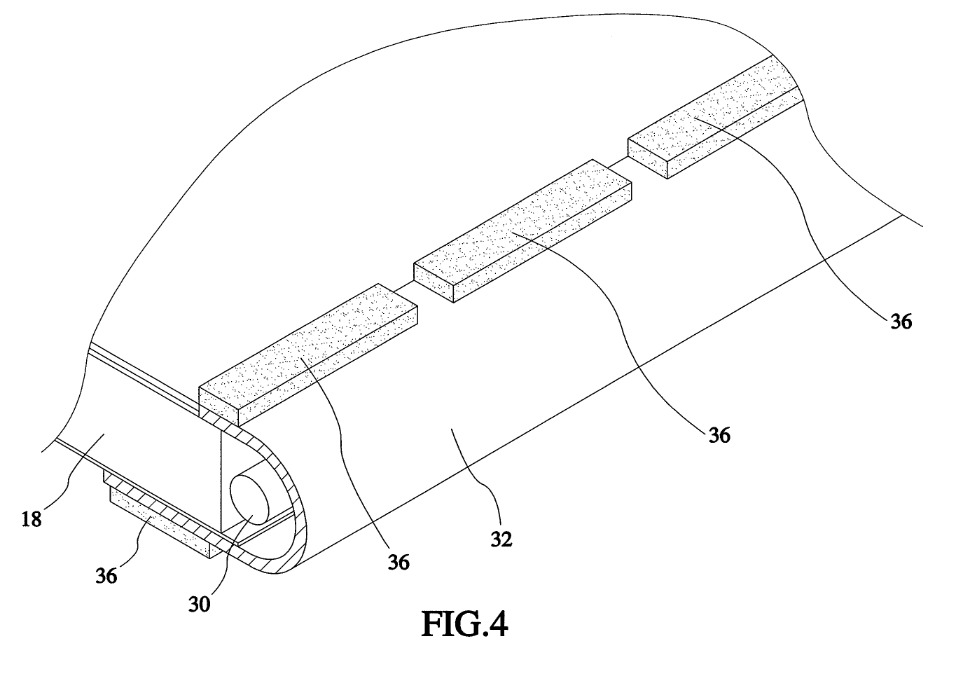

FIG. 3 shows the filler members 34 are two long strip-like members with a length as same as a width of the lamp reflector 32. In practice, they may have a plurality short sections 36 arranged in a layout with a predetermined interval therebetween, as shown in FIG. 4. The filler member also may provided on the top or bottom of the lamp reflector (not shown), and the opposite side of the lamp reflector is pressed on the module frame directly (not shown).

The advantages of the present invention include:

1. The filler member elastically press the lamp reflector to have the lamp reflector tightly pressed on light guide plate that may overcome the light linkage because of the deformation of the soft lamp reflector.

2. Typically, the upper frame is made by injection molding that the upper frame always has a waved profile on the interior side. The filler member of the present invention may have a side complementing the waved profile of the upper frame by its flexible property and have a flat opposite side pressing the lamp reflector to make the lamp reflector tightly pressing the light guide plate.

3. A further function of the present invention is that there is no space for dust or bits come from the friction of the module frame and some metal elements going into a visual region of the backlight module.

4. The filler member may make the lamp reflector holding the light guide plate firmly to have less shifting in the module frame.

What is claimed is:

1. An edge-light backlight module, comprising:
a module frame having a window thereon;
a light guide plate, which is received in the module frame, having an enter side, an exit side, and a bottom side;
a light source received in the module frame and facing the enter side of the light guide plate;
a lamp reflector received in the module frame and enclosing the light source, wherein the lamp reflector is made of a soft material and has at least an overlapping portion overlapped with the light guide plate; and
a filler member received in the module frame between the overlapping portion of the lamp reflector and an interior side of the module frame;
wherein the filler member has opposite sides touching the overlapping portion of the lamp reflector and an interior side of the module frame respectively to press the overlapping portion of the lamp reflector on the light guide plate.

2. The edge-light backlight module as defined in claim 1, wherein there are two of the filler member, one of which is on a top of the lamp reflector and the other of which is on a bottom of the lamp reflector.

3. The edge-light backlight module as defined in claim 1, wherein the filler member is a long strip-like member with a length substantially as same as a width of the lamp reflector.

4. The edge-light backlight module as defined in claim 1, wherein the filler member has a plurality of short sections with predetermined intervals therebetween.

5. The edge-light backlight module as defined in claim 1, wherein the filler member is attached on the interior side of the module frame.

6. The edge-light backlight module as defined in claim 1, wherein the filler member is directly projected from the interior side of the module frame.

7. An edge-light backlight module, comprising:
a module frame having an upper frame and a bottom plate;
a light guide plate, which is received in the module frame, having an enter side, an exit side, and a bottom side;
a light source received in the module frame and facing the enter side of the light guide plate;
a lamp reflector received in the module frame and enclosing the light source, wherein the lamp reflector is made of a soft material and has two overlapping portions overlapped with the exit side and the bottom side of the light guide plate; and
two filler members received in the module frame, one of which is between the overlapping portion of the lamp reflector and an interior side of the upper frame of the module frame and the other of which is between the overlapping portion of the lamp reflector and an interior side of the bottom plate of the module frame;
wherein each of the filler members has opposite sides touching the overlapping portions of the lamp reflector and upper frame and bottom plate of the module frame respectively to press the overlapping portions of the lamp reflector on the exit side and the bottom side of the light guide plate respectively.

8. The edge-light backlight module as defined in claim 7, wherein the filler member is a long strip-like member with a length substantially as same as a width of the lamp reflector.

9. The edge-light backlight module as defined in claim 7, wherein the filler member has a plurality of short sections with predetermined intervals therebetween.

10. The edge-light backlight module as defined in claim 7, wherein the filler member is attached on the interior side of the module frame.

11. The edge-light backlight module as defined in claim 7, wherein the filler member is directly projected from the interior side of the module frame.
